(19) United States
(12) Patent Application Publication
(10) Pub. No.: US 2018/0368190 A1
(43) Pub. Date: Dec. 20, 2018

(54) TRANSMISSION OF DATA OVER CLIENT PROBE FRAMES

(71) Applicant: Microsoft Technology Licensing, LLC, Redmond, WA (US)

(72) Inventors: Bengt-Erik Norum, Duvall, WA (US); Yongguang Zhang, Medina, WA (US)

(73) Assignee: Microsoft Technology Licensing, LLC, Redmond, WA (US)

(21) Appl. No.: 15/624,616

(22) Filed: Jun. 15, 2017

(51) Int. Cl. H04W 76/02; H04L 29/08; H04L 12/26; H04W 4/02

(52) U.S. Cl. CPC H04W 76/02; H04W 4/02; H04L 43/12; H04L 67/12

(57) ABSTRACT

A method of implementing data transmission in a wireless network by utilizing modified probe messages originally intended for link setup purposes is disclosed. A device receives first data from a determiner circuit, generates a probe message including a field defined to carry second data used for set up of communications between the device and a network, modifies the probe message by inserting the first data into the field in place of the second data, and sends the first data to a data service by transmitting the probe message to the network. This provides an efficient way of sending data that utilizes existing infrastructure and does not require adding messages or modifications to an air interface. The data is transferred from a device in a single message of an air interface in an “unconnected” manner without needing to go through resource intensive channel setup procedures normally needed for data transfer.

### BACKGROUND

Networks that support communications with wireless devices have become ubiquitous. These wireless networks commonly operate according to one or more standards that define the wireless communications interfaces to be used between the network and devices. The use of standardized wireless interfaces allows compatible devices and infrastructure equipment to be manufactured by different manufacturers for operation in specific wireless networks. In recent years, several types of standardized wireless interfaces have become predominant and large numbers of networks and devices operating according to these standards are widely dispersed geographically.

For example, wireless local area networks (WLANS) that operate according to the IEEE 802.11 Wi-|Fi standards are now widely implemented. WLAN environments may include, for example, corporate environments in which a large number of employees using many different types of devices are supported across a company's location or campus, public areas, such as airports or metropolitan areas, businesses, such as restaurants, stores, etc., Wi-Fi hotspots implemented by cellular service providers to support customer devices while located in the Wi-Fi area, or home WLAN environments in which multiple computing devices, gaming devices, and smart televisions may be supported. The majority of the networks offer some type of connection to the internet for Wi-Fi devices and some of these larger WLAN networks may offer coverage over a substantially large geographic region. Even though the smaller WLAN networks are not operated in a coordinated manner, taken as groups, these smaller networks may also cover large geographic areas. This installed base of widely dispersed large and small WLAN networks and equipment provides opportunities for leveraging the common air interface to provide enhanced services or functions.

### SUMMARY

This summary is provided to introduce a selection of concepts in a simplified form that are further described below in the Detailed Description. This summary is not intended to exclusively identify key features or essential features of the claimed subject matter, nor is it intended as an aid in determining the scope of the claimed subject matter.

Systems, methods and apparatus that provide transmission of data using probe messages are disclosed. Embodiments include a device that receives first data from a determiner circuit, generates a probe message including at least one field defined to carry second data used for set up of communications between the device and a network, modifies the probe message by inserting the first data into the at least one field of the probe message in place of the second data, and sends the first data to a data service by transmitting the probe message to the network. The embodiments provide a resource efficient way of sending data that may utilize existing infrastructure and does not require adding new messages or modifications to an existing air interface. The embodiments also allow data to be transferred from a device in a single message of a specified air interface in an “unconnected” manner without the need to go through resource intensive data channel setup procedures normally needed for data transfer. In an implementation, the device may comprise an IEEE 802.11 (Wi-Fi) device and the probe message may comprise a probe request message according to the Wi-Fi standard. The device may be a dedicated data collection device with only a transmitter implemented for collecting data and sending the data in probe request messages to a W-Fi network. The device may also be implemented as part of a mobile device such as a smartphone. The determiner circuit may comprise a sensor circuit that provides data from one or more sensors. The first data may comprise global positioning satellite data. The first data may also comprise any other type of data or measurement parameter determined by the determiner circuit.

In another embodiment, an apparatus in a wireless network may receive a probe message from a device, identify the probe message as a message type defined to include at least one field for carrying first data for set up of communications between the device and the wireless network, determine that the probe message is a modified probe message by determining that the at least one field includes second data in place of the first data, wherein the second data is not related to set up of communications between the device and the wireless network, and, in response to the determination that the at least one field includes the second data, determine a destination for the second data from the at least one field, and send the second data to the destination. In an implementation, the apparatus in the wireless network may comprise a Wi-Fi access point that is modified to process probe request messages to allow data transmission according to the embodiment. In another example implementation, the apparatus may be a dedicated data collection access point configured to process Wi-Fi probe request messages according to the embodiments.

### BRIEF DESCRIPTION OF THE DRAWINGS

FIG. 1 is a simplified diagram of a system in which embodiments of data transmission over client probes may be implemented;

FIG. 2A is a flow diagram illustrating operations in a device according to an example implementation;

FIG. 2B is a flow diagram illustrating operations in an apparatus when receiving data from the device of FIG. 2A;

FIG. 3A is a flow diagram illustrating operations according to another example implementation;

FIG. 3B is a flow diagram illustrating operations in an apparatus when receiving data from the device of FIG. 3A;

FIG. 4 is a simplified block diagram of an example mobile device and access point which may be implemented in the system of FIG. 1; and,

FIG. 5 is a simplified diagram of a modified probe request message according to an example implementation.

### DETAILED DESCRIPTION

The system, method and apparatus will now be described by use of example embodiments. The example embodiments are presented in this disclosure for illustrative purposes, and not intended to be restrictive or limiting on the scope of the disclosure or the claims presented herein.

The embodiments provide a resource efficient way of sending data that utilizes existing infrastructure and does not require adding new messages or modifications to an existing air interface. Both of the existing air interface and the existing infrastructure may be utilized. Implementations may be realized by configuring a transmitting device and one or more receiving devices to utilize one or more data fields in a probe message that is defined for use in data channel setup. Modified probe messages may be used to convey data from the device without requiring actual data channel setup or exchange of additional setup messages. Data may be transferred from a source device to a destination in a single message over a specified air interface in an “unconnected” manner. There is no need to go through the resource intensive data channel setup procedures that are normally used between a transmitter and receiver initiating data transfer. A device for transmitting data according to the implementations may be implemented using only a simple transmitter, since the probe message is the only message that is needed to convey the data to a network. The method does not require exchange of additional setup messages for data transfer between the device and a network. An apparatus for receiving data according to the implementations may be implemented in a network using only a receiver, or by modifying only the receiver of existing infrastructure to decode the one or more data fields to determine that a probe message is modified and that data is being sent in the probe message. Also, the embodiments may take advantage of a large number of networks that are widely dispersed over a geographic region, by allowing utilization of the air interface of the existing networks over the geographic region for data collection by modifying one or more receivers of the existing networks. This would be advantageous, for example, in Internet of Things (IoT) data collection applications.

The embodiments provide advantages when implemented in probe messages of a standardized network. For example, in an 802.11 Wi-Fi network, sending data from a device requires creation of an association between a device client and an access point of the network. Wi-Fi link setup requires transmission of at least 7 wireless Ethernet frames between the device and the access point. These include the device sending a Probe Request message and the access point responding with a Probe Response message, the device sending an Authentication Open message and the access point responding with an Authentication Open Seq. 2 message, the device sending an Association Request message and the access point responding with an Association Response message, and, finally, the device sending the data to the access point. If the device moves out of range of the access point or if an obstruction comes between the client and AP, the session is lost and must be reestablished. In an implementation of the embodiments in an 802.11 Wi-Fi network, information may be conveyed in an “unconnected” manner by injecting meaningful data into the SSID field of the 802.11 Probe Request message frame and the sending of the other Wi-Fi link setup messages may be avoided. Information may be conveyed at distances that are not possible when using traditional Wi-Fi/IP. In this implementation, using data transmission over the layer 2 client probe frames allows further distances to be covered than when full IP connections are used for the data transmission.

The embodiments also provide advantages over other existing networks and methods for transmitting and collecting data from mobile devices. The embodiments may be implemented inexpensively, for example as compared to GSM/GPRS/LTE cellular data transmission solutions that are expensive and may require cost prohibitive licensing. The embodiments may be implemented using only a simple transmitter, providing advantages over networks such as Optimized Link State Routing Protocol (OLSR) networks or Better Approach to Mobile Adhoc Networking (BATMAN) mesh networks that are complex and require sufficient equipment density to cover a desired area when using mobile nodes. The embodiments also provide advantages over networks using Amateur Radio spectrum (Automatic Packet Reporting System (APRS)—Amateur Packet-Radio Link-Layer Protocol AX.25) which are low bitrate and require unique equipment to be deployed, or newer types of IoT RF devices such as the LoRa or Sigfox systems which require unique equipment to be deployed, and may present vendor lock-in problems.

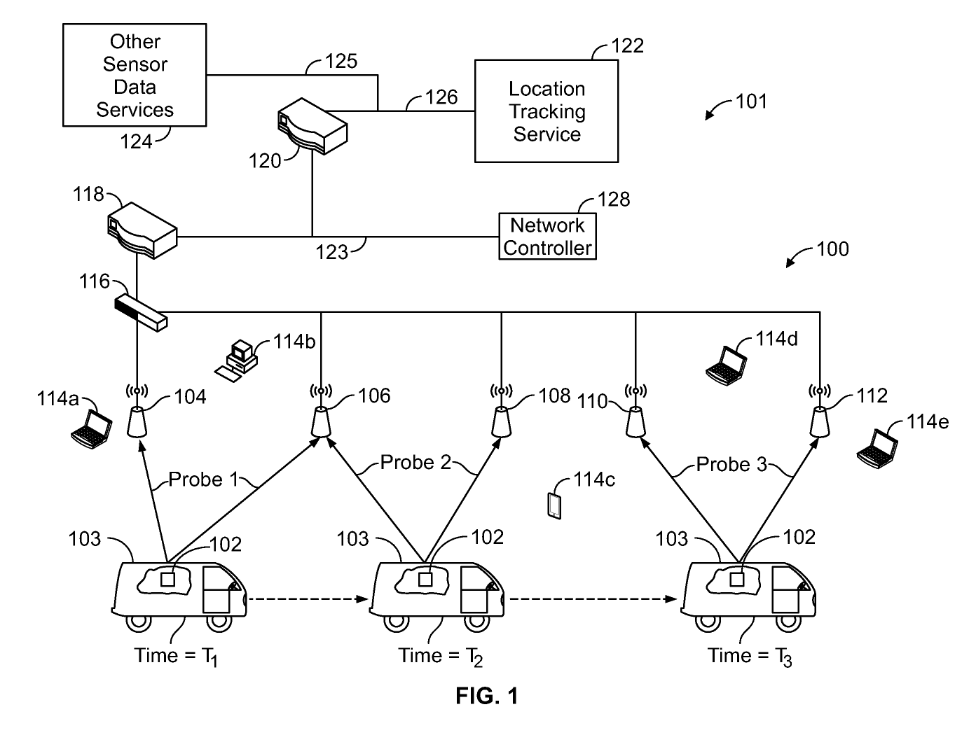

FIG. 1 is a simplified diagram of a system in which embodiments of data transmission over probe messages may be implemented. System 101 includes wireless network 100, which may be, for example, a local area network (WLAN) operating according to one or more of the 802.11 Wi-Fi standards. Network 100 includes router 120, access point/gateway 118, network controller 128, switch 116, and access points 104, 106, 108, 110, and, 112. In the implementation of FIG. 1, access points 104-112 may each be configured to receive and process modified probe request messages according to the embodiments. Each of access points 104-112 may operate as a conventional Wi-Fi access point having the additional capability to receive and process modified probe requests. Alternately, one or more of access point 104-112 may be implemented as a dedicated data collection device that is configured only to receive access probe messages and process the access probe messages according to the embodiments.

Router 120, access point/gateway 118, network controller 128, and switch 116 may be configured to provide traffic routing and switching functions for traffic to and from the access points 104, 106, 108, 110, and 112 over the infrastructure. Mobile devices 114a-114e are shown operating within the coverage area of network 100. Mobile devices 114a-114e may communicate in a conventional manner with a nearby access point of access points 104, 106, 108, 110, and, 112, over channels configured according to the Wi-Fi standards. System 101 also includes location tracking service 122 and other sensor/data services 124. Additionally, vehicle 103 is shown moving within the coverage area of network 100. Vehicle 103 includes a device 102 that is configured to transmit data using probe messages at selected times according to the embodiments. Device 102 may be a dedicated device, for example, device 102 may comprise transmitter configured only to transmit probe messages containing data collected from a sensor or other data generating device. Device 102 may also be a device such as a smartphone or tablet computer that includes an application for collecting data and transmitting the data using probe messages. Vehicle 103 is shown at points in time T₁, T₂, and T₃, as it moves within the coverage area of network 100. In the example implementation of FIG. 1, device 102 may comprise global positioning satellite (GPS) circuitry that periodically determines the location of device 102 as vehicle 103 moves and transmits location data in Wi-Fi probe request messages to track vehicle 103. The modified probe request messages may then be received by one or more of access point 104-112 and sent onward to location tracking service 122.

Location tracking service 122 and other sensor/data services 124 may represent any type of service that may utilize data transmit by device 102 and may be representative of computing/server functions or server systems provided by one or more servers or computing devices that are co-located or geographically dispersed. For example, location tracking service 122 may comprise a company or business service that tracks company vehicles, such as vehicle 103, as employees perform services.

In other example implementations, one or more of devices 114a-114e may also be configured with an application for collecting data and transmitting the data using modified probe messages. While devices 114a-114e are each shown as implemented as one of an example smart phone, a desktop computer, or laptop computer device, each of the example devices 114a-114e may be alternatively implemented as any other type of device, or number of devices, that may be configured with functionality supporting data transmission suing probe messages according to the embodiments disclosed herein. These other types of devices may include, for example, gaming devices, media devices, smart televisions, home theater systems, smart automobile systems, smart house systems, multimedia cable/television boxes, smart phone accessory devices, tablet accessory devices, personal digital assistants (PDAs), portable media players, smart watches, or industrial control systems.

In the example implementation of FIG. 1, network 100 may operate over a range of frequencies according to IEEE 802.11 standards specifications. The frequency range may include frequency bands in the range of 300 MHz to 90 GHz, each according to the 802.11 specification for the particular frequency band. For example, network 100 may include access points 104-112 that each include transceivers operable according to one or more of the 802.11a (5 GHz), 802.11b (2.4 GHz), 802.11g (2.4 GHz), 802.11n (2.4/5 GHz), 802.11ac (5 GHz) standards. The access points 110-114 may be capable of communicating on channels of various band widths within the frequency ranges according to the version of the standards being used for the communications.

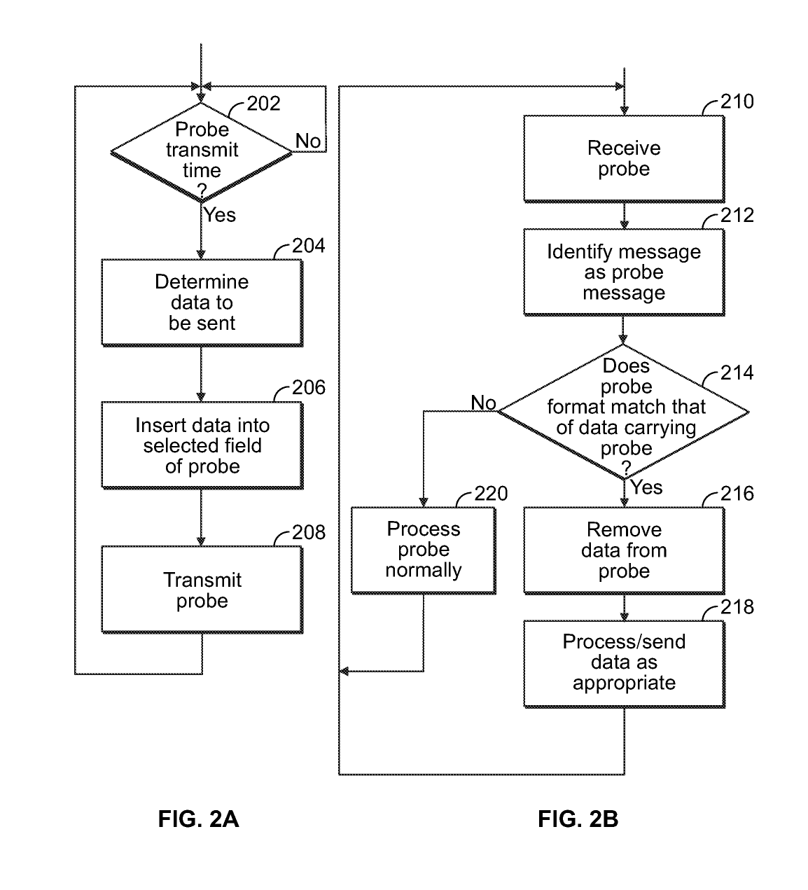

FIG. 2A is a flow diagram illustrating example operations in a device transmitting data according to the embodiments. The device of FIG. 2A may be any device that is configured to transmit data using modified probe messages. For example the device may represent device 102 of FIG. 1. In other implementations, the device of FIG. 2A may represent any of devices 114a-114e that are configured to collect data and transmit the data using modified probe messages according to the embodiments.

At 202, the device determines if it is time to transmit data. If it determined that it is not time to transmit data, the process returns to 202 and repeats operation 202 until it is determined that it is time to transmit data. If, however, at 202 it is determined that it is time to transmit data, the process moves to 204. At 204, device 102 determines the data to be sent. Device 102 may retrieve the data to be sent from memory. The data to be sent may be any type of data. The data may be received from a sensor circuit or may be collected in another manner. At 206, the device inserts the data into a selected field of a probe message. The device may insert the data by generating a probe message that includes at least one field defined to carry setup data used for set up of communications between the device and a network. The device may then modify the probe message by inserting the data to be sent in the at least one field of the probe message in place of the setup data. For example, in an implementation in a Wi-Fi device, the device may insert the data into the service set identifier field and/or the supported rates field of a probe request message in place of service set data or supported rates data. The device may also include an identifier with the data that identifies the probe message as being a modified message carrying data, or a selected type of data, not intended for use in setup of communications between the device and the network. Next, at 208, the device transmits the first data to a data service by transmitting the probe message to the network.

FIG. 2B is a flow diagram illustrating operations performed in an apparatus receiving data from a device operating according to FIG. 2A. The apparatus of FIG. 2B may be any apparatus that receives and processes data using probe messages according to the embodiments. For example the apparatus may represent one or more of access points 104-112 of FIG. 1.

At 210, the apparatus receives a probe message. At 212, the apparatus identifies the message as a probe message. For example, the message may include a field identifying the message to the apparatus as a probe message. Next, at 214 the apparatus determines if the probe format matches that of a data carrying probe. In an implementation in a Wi-Fi network, the apparatus may be operating on the wireless interface using promiscuous mode filtering for management frames with subtype probe-req that match the expected data carrying format.

If the apparatus determines that the probe format does not match that of a data carrying probe, the process moves to 220 where the probe is processed for setup as a normal probe message. If the apparatus determines that the probe format does match that of a data carrying probe, the process moves to 216. The apparatus may perform the determination at 214 by determining that data sent by a device was inserted into at least one field of the probe message in place of setup data. For example, in an implementation in a Wi-Fi network, the apparatus may determine that data sent by a device was inserted into the service set identifier field and/or the supported rates field of the probe request message in place of service set identifier data or supported rates data. The apparatus may perform the determination by determining that an identifier is included with the data that identifies the probe message as being a modified message carrying data, or a selected type of data, not intended for use in setup of communications between the device and the network. At 216, the apparatus removes the data from the probe message and, at 218, processes the data and sends the data to its intended destination.

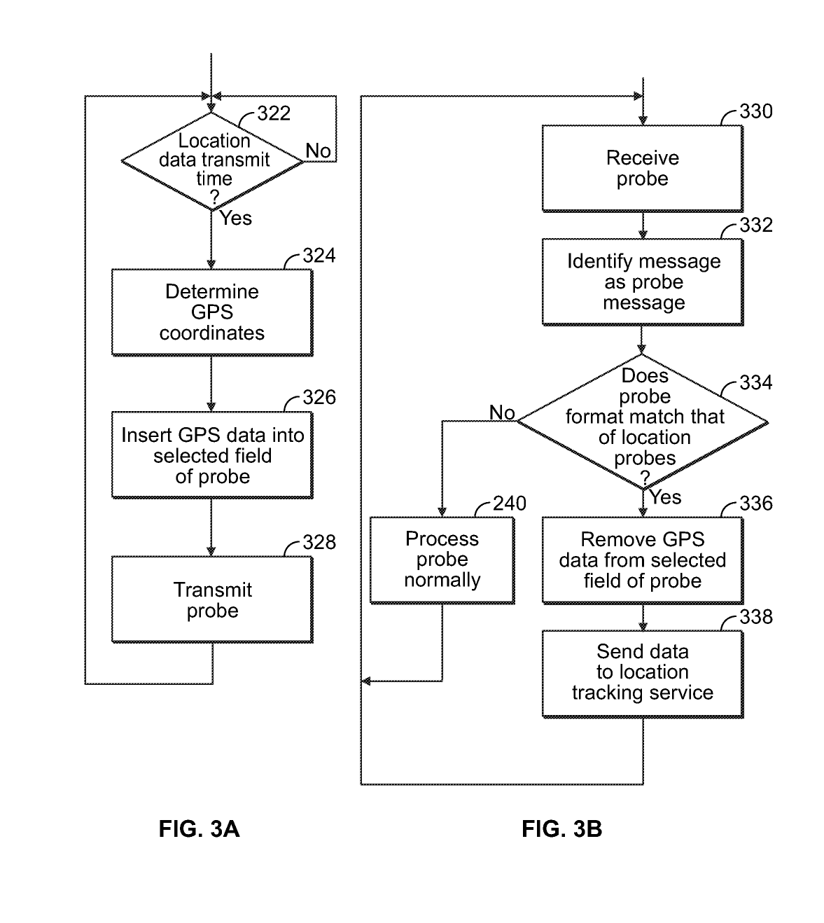

Referring now to FIG. 3A, is a flow diagram illustrating example operations in a device transmitting data according to an implementation of the embodiments. The device described in FIG. 3A may represent device 102 of FIG. 1. In other implementations, the device of FIG. 3A may represent any of devices 114a-114e that are configured to collect data and transmit the data using modified probe messages according to the operations of FIG. 3A. FIG. 3A may be explained with reference to device 102 as device 102 tracks the location of vehicle 103 as vehicle 103 moves within the coverage areas of network 100.

At 322, device 102 determines if it is time to transmit location data. If it is determined that it is not time to transmit location data, the process returns to 322 and repeats operation 322 until it is determined that it is time to transmit data. If, however, at 322 it is determined that it is time to transmit data, the process moves to 324. At 324, device 102 determines the location data to be sent. Device 102 may retrieve the location data to be sent from memory. The location data may be data that was received from a GPS sensor circuit and stored in the memory over a time period as vehicle 103 has moved. In another example, the location data may be determined from GPS sensor circuitry at the time a determination that it is time to transmit location data is made at 322.

At 326, the location data is inserted into a selected field of a probe message that is normally used to carry communication link setup data. The GPS data may be transformed to fit inside at least one field in the probe message. For example, the GPS data may be transformed into a 32 character field for transmission in the shared system identifier (SSID) field of a Wi-Fi probe request message. If needed, supported rates field of a Wi-Fi probe message may also be used to carry the location data. Also, more than one probe message may be used to send the data if a single message is not large enough. Device 102 may also include an identifier with the GPS data that identifies the probe message as being a modified message carrying data, or a selected type of data, not intended for use in setup of communications between the device and the network. Next, at 328, device 102 transmits the location data to location tracking service 122 by transmitting the probe message to the network where the receiving access point forwards the location data to location tracking service 122. FIG. 1 illustrates the operations of FIG. 3A being repeated over a time sequence at times T₁, T₂, and T₃ as vehicle 103 moves throughout the coverage area of network 100 to track movement of vehicle 103. At time T₁, device 102 sends probe 1 which may be received at access point 104 and/or access point 106, at time T₂, device 102 sends probe 2 which may be received at access point 106 and/or access point 108, and, at time T₃, device 102 sends probe 3 which may be received at access point 110 and/or access point 112. Each of the access points that receive the modified probe message and are configured to recognize the modified probe request message as including location data will forward the data onward to location tracking service 122. In another implementation, the location data may be only transmitted by device 102, whenever device 102 determines from the GPS circuitry that the location of vehicle 103 has changed greater than a threshold amount. For example, every time vehicle 103 moves more than a specified distance from its previous sent location, device 102 may send updated location data.

FIG. 3B is a flow diagram illustrating operations performed in an apparatus receiving data from a device operating according to FIG. 3A. The apparatus of FIG. 3B may be any apparatus that receives and processes data received in modified probe messages according to the embodiments. For example the apparatus may represent one or more of access points 104-112 of FIG. 1 that has been configured to recognize modified probe request messages.

At 330, the access point receives a probe message. At 332, the access point identifies the message as a probe message. For example, the message may include a field identifying the message to the apparatus as a Wi-Fi probe request message. The apparatus may be operating on the wireless interface using promiscuous mode filtering for management frames with subtype probe-req that match the data carrying format.

Next, at 334 the access point determines if the probe format matches that of a data carrying probe. If the access point determines that the probe format does not match that of a data carrying probe, the process moves to 340 where the probe is processed for setup as a normal probe message. If the access point determines that the probe format does match that of a data carrying probe, the process moves to 336. The access point may perform the determination at 334 by determining that location data sent by a device was inserted into at least one field of the probe message in place of setup data. For example, in an implementation in a Wi-Fi device, the apparatus may determine that location data sent by a device was inserted into the service set identifier field and/or the supported rates field of the probe request message in place of service set identifier data or supported rates data. The access point may perform the determination by determining that an identifier is included with the location data that identifies the probe message as being a modified message carrying location data, or a selected type of location data, not intended for use in setup of communications between the device and the network. At 336, the access point removes the location data from the probe message and, at 338, processes the data and sends the data to its intended destination. The location data may be inserted into the probe message along with identifying data, such as an IP address, that allows the access point to determine a destination, such as location tracking service 122, to which the location data is to be sent.

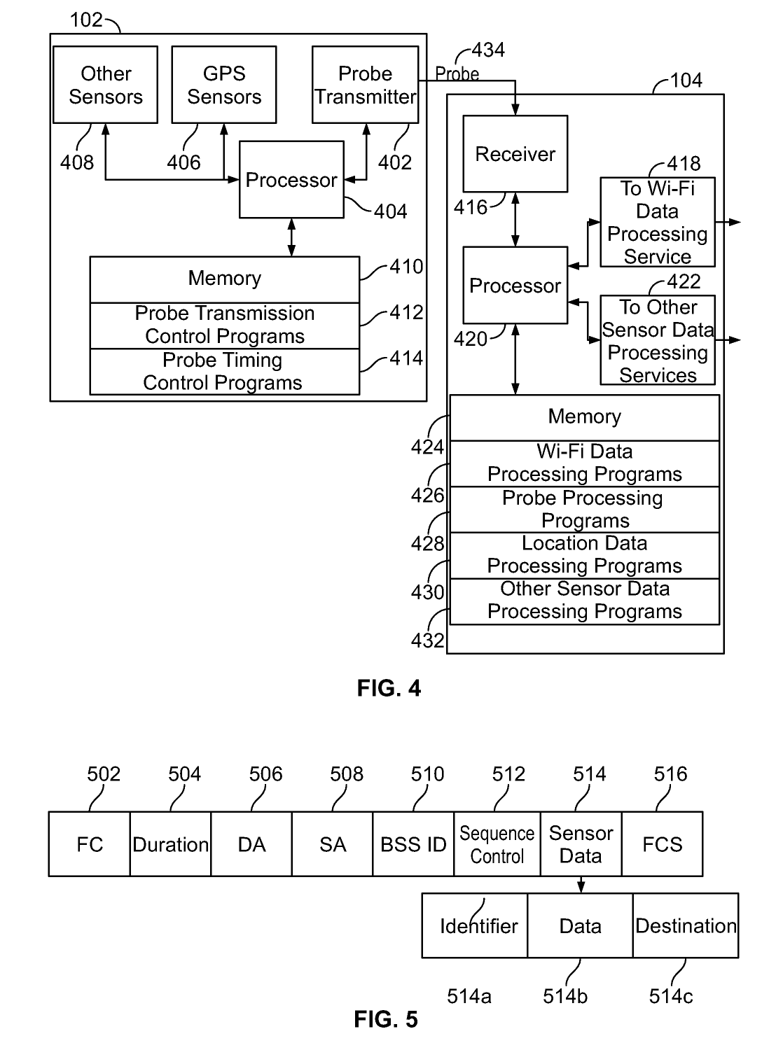

FIG. 4 is a simplified block diagram of an example device 102 and an example apparatus 104 that may be implemented in network 100 to perform the operations shown in FIGS. 2A and 2B, and, 3A and 3B. Device 102 represents a possible implementation of device 102, or portions of devices 114a-114e, or any other device that may operate in network 100, according to the embodiments of the disclosure to send data using probe 434. Apparatus 104 represents a possible implementation of portions of access points 104-112 for receiving data transmitted in probe 434.

Device 102 includes probe transmitter 402. Probe transmitter 402 may be implemented to transmit probe messages on one or more Wi-Fi frequencies. Device 102 may also include GPS sensors 406 for generating location data that may be transmit from device 102 using probe 434. Device 102 may also include data input/outputs (I/O) 408 for receiving other data from other types of devices that may be transmit from device 102 using probe 434. The other types of devices may include, for example, health monitor devices, weather monitors, industrial supervisory control and data acquisition (SCADA) equipment, or, generally, any function that may collect data. Device 102 includes processor 404 and memory 410 which is shown as including program code or instructions for probe transmission control programs 412 that perform functions according to the embodiments. Memory 410 may also include probe transmission timing control programs. Memory 410 may be implemented as any type of computer readable storage media in device 102, including non-volatile and volatile memory. Memory 410 also includes instructions in the form of code for running the operating system to control the operations of device 102. Processor 404 may comprise one or more processors, or other control circuitry or any combination of processors and control circuitry. Processor 404 provides overall control of device 102 by implementing instructions and code in memory 410 to provide functions for operation of device 102 according to FIGS. 2A and/or 3A.

Apparatus 104 includes receiver 416, processor 420, interface to Wi-Fi data processing services 418, interface to other sensor data processing services 422, and memory/storage 424 that includes code and instructions for Wi-Fi data processing programs 426, probe processing programs 428, location data processing programs 430, and other sensor data processing programs 432. Memory 424 may be implemented as any type of computer readable storage media, including non-volatile and volatile memory. Apparatus 104 connects to a backend network over interfaces 418 and 422. Processor 420 may comprise one or more processors, or other control circuitry or any combination of processors and control circuitry that provide overall control of apparatus 104 according to the disclosed embodiments.

In an implementation of apparatus 104, Wi-Fi data processing programs 426, probe processing programs 428, location data processing programs 430, and other sensor data processing programs 432, when executed, cause processor 420 to control apparatus 104 to perform operations as shown in FIGS. 2B and 3B. For example, Wi-Fi data processing programs 426 may cause processor 420 to perform the operations of 210 and 212, probe processing programs 428 may cause processor 420 to perform the operations of 214 and 216, and location data processing programs 430, and other sensor data processing programs 432 may cause processor 420 to perform the operations of 218.

The example embodiments disclosed herein may be described in the general context of processor-executable code or instructions stored on memory that may comprise one or more computer readable storage media (e.g., tangible non-transitory computer-readable storage media such as memory 410 or 424). As should be readily understood, the terms “computer-readable storage media” or “non-transitory computer-readable media” include the media for storing of data, code and program instructions, such as memory 410 or 424, and do not include portions of the media for storing transitory propagated or modulated data communication signals.

FIG. 5 is a simplified block diagram of a probe message 500 for transmitting data according to an example implementation. Probe message 500 may be a modified Wi-Fi probe request message that includes frame control (FC) 502, duration 404, destination address (DA) 406, source address (SA) 508, base station set ID (BSS ID) 410, sequence control 512, and (FCS) 416. The FC 502 indicates that the probe message is in the probe request format. The duration field 404 may be set as defined for the probe request frame type. The destination address (DA) 406 may be set to indicate that the probe is being broadcast to any access point that may receive the probe. The source address (SA) 508 may be set to the address of device 102. The base station set ID (BSS ID) 410 may be set to indicate the wildcard or null value. The sequence control 512 field may be set to indicate whether the data is fragmented, i.e., whether the data is to be sent in one or more probe messages. In the implementation of FIG. 5, probe message 500 is modified to include sensor data 514 which is inserted in the field reserved for service set identifier information and/or supported rates information in place of the service set identifier information and/or supported rates information. The service set identifier information and/or supported rates information carries information used for setup of a communications link between a device sending the probe message and an access point of a Wi-Fi network. In one example implementation, the sensor data 514 may include an identifier 514a, the actual data 514b, and a destination 514c for the data. Identifier 514a may be used to indicate to a receiving apparatus that the probe message 500 is being used to transmit data and is not intended for setup. Destination 514c may be included to indication an address, such as an IP address, to which the receiving apparatus may send the data 514b.

The disclosed implementations include a device comprising a processor, a transmitter coupled to the processor, where the transmitter is configured to transmit on at least one channel, and, memory coupled to the processor, the memory including code executable to cause the at least one processor to receive first data from a sensor circuit, generate a probe message including at least one field defined to carry second data used for set up of communications between the device and a network, modify the probe message by inserting the first data in the at least one field of the probe message in place of the second data, and, control the transmitter to send the first data to a data service by transmitting the probe message to the network. The at least one field of the probe message may comprise a service set identifier field. The at least one field of the probe message may comprise a supported rates field. The code may be further executable to cause the processor to insert third data with the first data in the at least one field of the probe message, wherein the third data identifies the probe message as carrying the first data. The probe message may comprise a probe request message. The first data may comprise global positioning satellite data. The device may be implemented in a vehicle. The first data may comprise at least one measurement parameter determined by the sensor circuit. The sensor circuit may be implemented in the device.

The disclosed implementations further include an apparatus in a wireless network comprising a processor, a receiver coupled to the processor, and, memory, coupled to the processor, the memory including code executable to cause the at least one processor to control the apparatus to receive a probe message from a device at the receiver, identify the probe message as a message type defined to include at least one field for carrying first data for set up of communications between the device and the wireless network, determine that the at least one field includes second data in place of the first data, wherein the second data is not related to set up of communications between the device and the wireless network, determine, in response to the determination that the at least one field includes the second data, a destination for the second data from the at least one field, and, send the second data to the destination. The at least one field of the probe message may comprise a service set identifier field. The at least one field of the probe message may comprise a supported rates field. The at least one field of the probe message may further include third data, wherein the third data identifies the probe message as carrying the second data and the code may be further executable to cause the at least one processor to control the apparatus to determine that the at least one field includes the second data in place of the first data by controlling the device to identify the third data. The probe message may comprise a probe request message. The second data may comprise at least one measurement parameter determined by a remote sensor circuit.

The disclosed implementations further include a wireless network comprising a plurality of access points, wherein each of the plurality of access points is configured to receive a probe message from one or more mobile devices operating in the coverage area of the wireless network, identify the probe message as a message type defined to include at least one field for carrying first data for set up of communications between the device and the wireless network, determine that the at least one field includes second data in place of the first data, wherein the second data is not related to set up of communications between the device and the wireless network, determine, in response to the determination that the at least one field includes the second data, a destination for the second data from the at least one field, and, send the second data to the destination. The probe message may comprise a probe request message. The wireless network may further include the one or more mobile devices, wherein each of the one or more mobile devices is configured to receive first data from a sensor circuit, generate the probe message including the at least one field defined to carry the first data used for set up of communications between the device and the wireless network, insert the second data in the at least one field of the probe message in place of the first data, and, send the first data by transmitting the probe message to the network. The wireless network may comprise a Wi-Fi network.

While the functionality disclosed herein has been described by illustrative example using descriptions of the various components and devices of embodiments by referring to functional blocks and processors or processing units, controllers, and memory including instructions and code, the functions and processes of the embodiments may be implemented and performed using any type of processor, circuitry or combinations of processors and/or circuitry and code. This may include, at least in part, one or more hardware logic components. For example, and without limitation, illustrative types of hardware logic components that can be used include field programmable gate arrays (FPGAs), application specific integrated circuits (ASICs), application specific standard products (ASSPs), system-on-a-chip systems (SOCs), complex programmable logic devices (CPLDs), etc. Use of the term processor or processing unit in this disclosure is mean to include all such implementations.

Although the subject matter has been described in language specific to structural features and/or methodological acts, it is to be understood that the subject matter defined in the appended claims is not necessarily limited to the specific features or acts described above. Rather, the specific features and acts described above are disclosed as example embodiments, implementations, and forms of implementing the claims and these example configurations and arrangements may be changed significantly without departing from the scope of the present disclosure. Moreover, although the example embodiments have been illustrated with reference to particular elements and operations that facilitate the processes, these elements, and operations may or combined with or, be replaced by, any suitable devices, components, architecture or process that achieves the intended functionality of the embodiment. Numerous other changes, substitutions, variations, alterations, and modifications may be ascertained to one skilled in the art and it is intended that the present disclosure encompass all such changes, substitutions, variations, alterations, and modifications as falling within the scope of the appended claims.

What is claimed is:

1. A device comprising:
a processor,
a transmitter coupled to the processor, the transmitter configured to transmit on at least one channel; and,
memory coupled to the processor, the memory including code executable to cause the at least one processor to:
receive first data from a sensor circuit;
generate a probe message including at least one field defined to carry data used for set up of communications between the device and a network;
modify the probe message by inserting the sensor data, an identifier identifying the probe as carrying the sensor data, and an identifier of a destination of the sensor data, in the at least one field of the probe message in place of the second data; and,
control the transmitter to send the sensor data to the destination by transmitting the probe message to the network.

2. The device of claim 1, wherein the at least one field of the probe message comprises a service set identifier field.

3. The device of claim 1, wherein the at least one field of the probe message comprises a supported rates field.

4. The device of claim 1, wherein the probe message comprises a probe request message.

5. The device of claim 1, wherein the sensor data comprises Global Positioning System (GPS) data.

6. The device of claim 5, wherein the device is implemented in a vehicle.

7. The device of claim 6, wherein the GPS data is updated periodically as the location of the vehicle changes.

8. The device of claim 1, wherein the sensor circuit is implemented within the device.

9. The device of claim 1, wherein the sensor circuit is implemented in a vehicle and sends GPS data to the device on a wireless interface.

10. An apparatus in a wireless network, the apparatus comprising:
a processor;
a receiver coupled to the processor; and,
memory, coupled to the processor, the memory including code executable to cause the at least one processor to control the apparatus to:
receive a probe message from a device at the receiver;
identify the probe message as a message type defined to include at least one field for carrying setup data for setup of communications between the device and the wireless network;
determine, based on an identifier identifying the probe as carrying sensor data, that the at least one field includes sensor data in place of the setup data and an identifier of a destination of the sensor data;
determine, based on the identifier of a destination of the sensor data, the destination for the sensor data; and,
send the second data to the destination.

11. The apparatus of claim 10, wherein the at least one field of the probe message comprises a service set identifier field.

12. The apparatus of claim 10, wherein the at least one field of the probe message comprises a supported rates field.

13. The apparatus of claim 10, wherein the probe message comprises a probe request message.

14. The apparatus of claim 10, wherein the sensor data comprises at least one Global Positioning Position (GPS) parameter determined by a remote sensor circuit.

15. A wireless network comprising:
a plurality of access points, wherein each of the plurality of access points is configured to:
receive a probe message from one or more mobile devices operating in the coverage area of the wireless network;
identify the probe message as a message type defined to include at least one field for carrying setup data for set up of communications between the device and the wireless network;
determine, based on an identifier identifying the probe as carrying sensor data, that the at least one field includes sensor data in place of the setup data and an identifier of a destination of the sensor data;
determine, based on the identifier of a destination of the sensor data, the destination for the sensor data; and,
send the sensor data to the destination.

18. The wireless network of claim 17, wherein the probe message comprises a probe request message.

19. The wireless network of claim 17, wherein the wireless network further includes the one or more mobile devices, wherein each of the one or more mobile devices is configured to:
receive sensor data from a sensor circuit;
generate the probe message including the at least one field defined to carry the setup data;
insert the sensor data in the at least one field of the probe message in place of the setup data; and,
send the sensor data by transmitting the probe message to the network.

20. The wireless network of claim 17 wherein the wireless network comprises a Wi-Fi network.
